(19) United States
(12) Patent Application Publication
(10) Pub. No.: US 2013/0173419 A1
(43) Pub. Date: Jul. 4, 2013

(54) RECOMMENDING REPEATED TRANSACTIONS

(71) Applicant: CERTONA CORPORATION, San Diego, CA (US)

(72) Inventors: Benjamin S. Farber, San Diego, CA (US); Geoffrey J. Hueter, San Diego, CA (US); Zachariah A. Freitas, Escondido, CA (US)

(73) Assignee: CERTONA CORPORATION, San Diego, CA (US)

(21) Appl. No.: 13/731,071

(22) Filed: Dec. 30, 2012

Related U.S. Application Data
(60) Provisional application No. 61/581,696, filed on Dec. 30, 2011.

(51) Int. Cl. G06Q 30/06

(52) U.S. Cl. CPC G06Q 30/0631
USPC 705/26.7

(57) ABSTRACT

A computer implemented web-based system and computer implemented web-based method is disclosed for recording, repeated transactions of objects or groups of objects by subjects, utilizing the duration between transactions to predict the next transaction time of an object by a subject, and recommending the object to the subject based on the predicted next transaction time. The system can also classify object according to their replenishment behavior and make product recommendations based on the class of objects a subject shows interest in. Objects include movies, books, songs, commercial products, news articles, advertisements or any other type of content or physical item. The system has application in personalization, behavioral targeting, Internet retailing, and interactive radio, to name but a few applications.

### FIELD OF THE INVENTION

The present invention relates to electronically marketing goods, services, content, and other entities through the automated analysis of human behavior. Particularly, the invention relates to the representation of subject and object characteristics for the purpose of efficient generation of recommendations. The system has application in personalization, behavioral targeting, Internet retailing, email segmentation and ad targeting, to name but a few applications.

### BACKGROUND OF THE INVENTION

The consumer faces a profound number of possible choices when selecting most kinds of products, be it movies, music, books, travel, art, dining, employers, and so on, to the extent that the consumer must choose from well-publicized possibilities, such as through advertising, or rely on recommendations of others. In the first case the set of choices is severely limited to those that can be promoted to a broad audience. In the second case the consumer must weigh. the similarity of his or her own tastes to the person making the recommendation, whether it is an acquaintance or media. In addition, the number of possibilities and the cost of acquisition, both in terms of time and money, of assessing possibilities, make it infeasible to sample a large number of possibilities to determine which are of interest to the consumer.

Recommendation systems rely on trying to best match a person's individual preferences to the characteristics of the available items. In general what is known about the subjects and objects is the set of affinities between subjects and objects, where the affinity {Aᵢⱼ} between subject i and object j is determined by explicit feedback from the subject or inferred from the subject's interaction (or non-interaction) with the object The consistency of the affinity scale from subject to subject and object to object derives from the consistency of the goal of the subjects in the given environment, for example to make a purchase in a commerce environment or to read articles in a content environment.

The primary goal of the recommendation system is to predict for a given subject those objects for which the subject will have the greatest affinity. In general the subject characteristics can be represented by a vector S=(S₁, S₂, . . . , S_{L}) and the object characteristics can be represented by a vector B=(B₁, B₂, . . . B_{M}), whereby the predicted affinity of the subject to the object is a function P=f(S, B). Various recommendation systems then differ in their representation of subject and object characteristics S and B and the similarity function f.

In a number of contexts, consumers make repeated transactions of the same item. For example, groceries, office supplies, airline flights, and news reports are regularly purchased or consumed in a repeated fashion. Similarly, consumers often make a series of transactions of related products, for example periodically replacing running shoes, getting the latest model of a car, or new offering from a brand of clothing. The frequency and duration between such repeated transactions is in and of itself a distinguishing element of these transactions. This is widely recognized as the premise for a variety of mass marketing efforts targeted at consumers, yet the vast majority of these efforts, by their very nature, are not customized to the purchasing patterns of an individual consumer. Recommendation systems are specifically designed to bridge that gap, but to date have not explicitly leveraged the information available from examining the intervals at which repeated transactions are made.

### SUMMARY OF THE INVENTION

The invention pertains to recording re-occurring transactions of a product, service, content or other entity, computing the next likely transaction date and time of a specific item by a particular subject, and using that date and time to make recommendations to that subject. The invention also pertains to classifying products by the frequency with which they are re-transacted in order to make product recommendations based on that classification. This invention is sometimes referred to in this patent by its commercial trademarked name, Resonance®.

An object of the invention is to provide a means of recommending objects to subjects based on either explicit or behaviorally interred ratings of that subject or other subjects of those objects and of commonly rated objects.

Another object of the invention is to create object profiles as well as subject profiles, so that objects can be readily indexed by aesthetic or other categories and so that objects can be readily associated across product categories by aesthetic similarity.

Another object of the invention is to create subject and object profiles that can be used to relate the derived aesthetic attributes to other objective measures of subjects, such as personality type or demographics, and objects, such as color, shape, or replacement interval.

Another object of the invention is to combine the recommendations of the system with explicit human merchandising objectives either through “hard” rules that filter results by specified criteria or “soft” rules that bias the results towards a defined business goal.

Another object of the invention is to identify appropriate subjects for the marketing of a particular object.

Another object of the invention is to automatically identify and classify items that are replenishment vs. durable

Another object of the invention is to use the classification of items as replenishment vs. durable to predict a subject's affinity and next transaction date for a particular item.

The present invention is a system and method for predicting subject responses to objects based on that subject and other subjects' repeated responses to that and other objects. The process of matching subject and object profiles produces a predicted response score that can be used to rank recommended content. The scores can be used as is or combined with other business logic to render the final recommendation rank. The invention can be applied to a broad range of applications, including the retailing of single consumption items, such as non-recurring purchases or content views, where the previous purchase or view of an object cannot be used to predict additional purchases or views of the same object. The invention can also be used to predict subject responses to recurring purchases and to recommend new consumables.

The invention considers the interaction of subjects and objects. The subject is an active entity that initiates transactions. The subject consumes or experiences objects and provides feedback on the level of satisfaction with the object. The subject could be a single person or a corporate entity, such as a business. The object is a passive target of interaction by the subject. This could be a physical object, such as a consumer good, for example cars, MP3 player, or ice cream; media, such as music, movies, hooks, art, or plays; or even a person, as in the case of a job search or a matchmaking service. In the case of active entities, it is possible for the subject and object to reverse roles depending on the situation.

The invention provides a novel solution to the problem of how to identify objects, for example products, that will appeal to a particular subject, for example a person, where the large number of possible objects, including less desirable objects that are descriptively similar but aesthetically different or where some objects may appeal highly to a limited population of subjects while being, undesirable to the broader population, makes it difficult for the subject to notice the objects that the subject wants simply by browsing the entire set of objects. This provides a breakthrough for target marketing and retail applications because it allows the consumer, solely by behavior, to “self-market” or “pull” those products which are of interest, rather than requiring that retailers “push” potentially unwanted products through advertising or other inefficient means,

The invention also addresses the issue of consumer privacy because it does not profile the consumer using personal demographics information, which consumers find both invasive and tedious to enter. Thus Resonance improves retailers' ability to target customers, while simultaneously making it easier for consumers to participate.

The invention works by forming profiles of subjects, for example consumers, and objects, such as goods or media, based on aesthetic evaluations of objects by subjects. The invention does not require a priori information about either subjects, such as demographics or psychographics, or objects, such as classifications or genres. Rather, it automatically generates representations of subjects and objects solely from the subjects' interaction with the objects. Because it creates its own abstract representation of subjects, it allows retailers to transparently target the subject without compromising, subject privacy through the collection and modeling of sensitive personal information. The profiles can also be extended across catalogs, product or content domains, or across websites or stores.

Note that the identification of subjects and objects is not necessarily a physical one and may change depending on the application. For example, in a consumer movie recommendation application, the person requesting recommendations is the subject and the movie is the object, in a dating, service application, a person would be considered a subject when searching for matches and an object when being searched by others. Similarly, in the case of employer/employee matching, companies and persons would alternate between the roles of subject and object. Note that in cases where an entity can assume different roles, a different profile would he created for each role.

Because the profiles are symmetric (both subjects and objects are profiled to the same representation), subjects can be matched to other subjects or objects, and objects can be matched to other objects or subjects. For example subject-subject matching could be used on a social networking site to connect people of like interests or on an online store to order product reviews according to the similarity of the reviewer to the reader. Similarly, object-object matching can be used to match keywords to products or content, advertisements to news articles, or promotional banners to referring affiliate sites.

Because of the large. number of weights or adapted parameters of the system, which scales as the number of subjects and objects, a key aspect of the method is that the weights for each subject or object are decoupled from other subjects and objects when updated separately. This allows individual subjects and objects to be trained by different processing units, which allows the method to scale up to large numbers of subjects and objects, which may ultimately total millions or tens of millions or more.

A key improvement of the invention over collaborative filters is that it creates not just profiles of the subjects, but profiles of the objects as well. This provides several advantages, including rapid and scalable prediction of subject to object affinities; straightforward cross marketing across product categories; and sorting of objects by aesthetic categories for purposes of browsing and selecting, items for consumption or association, such as selecting, musical recordings to go with a movie production.

Another key improvement of the invention over previous recommendation systems is that it exploits the duration between transactions, not just the quantity or date of transactions to predict subject to object affinities. This provides the advantage that the system can accurately predict when a subject will transact in addition to how likely they are to transact a particular item. The additional prediction of when a transaction will occur allows the system to recommend products when they are most likely to be appealing to a subject, maximizing the relevancy of the recommendations.

### BRIEF DESCRIPTION OF THE DRAWINGS

FIG. 1 shows the principal components of the system.

FIG. 2 shows the distribution of components across multiple computers on a network.

FIG. 3 shows an embodiment of the system using web services cm a distributed network.

FIG. 4 shows the operation of the system to record shopper history.

FIG. 5 shows the operation of the system to predict the next transaction date and time for an item by a subject.

FIG. 6 shows the operation of the system to generate product recommendations.

FIG. 7 shows the operation of the system to determine different types of products according to replenishment rate and exploit those characteristics when making product recommendations.

### DETAILED DESCRIPTION OF THE DRAWINGS

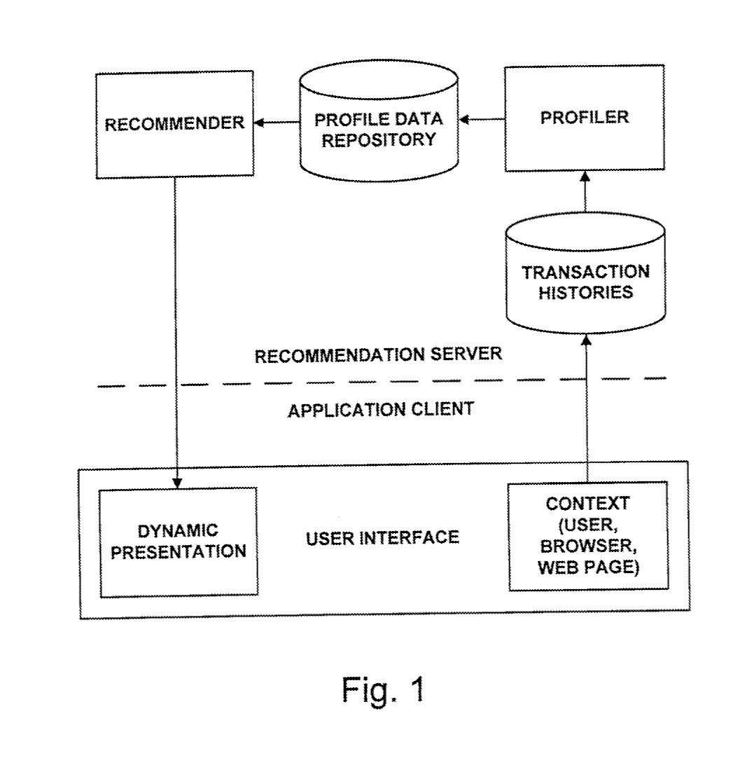

FIG. 1 shows the principal components of the computer implemented web-based system. As shown in FIG. 1, there is an application client and a recommendation system. The end-user interface can be implemented using a variety of devices, including a personal computer, an in-store kiosk, a personal digital assistant (PDA), a mobile phone, a mobile tablet, a set top box, a wireless device or an ordinary telephone with voice capability. The recommendation system is typically a computer or collection of computers within a network or across the Internet. As an alternative embodiment the recommendation request can be made through an intermediate server, which then renders the recommendations to the user interface.

A subject interacts with the user interface. The user interface makes a request to the recommendation system, which returns personalized content based on the context of the request, where the context of the request includes the identity of the subject, the specific type of system, such as desktop computer or mobile phone, the physical location of the subject, the specific page of the application being viewed, or any other known attributes that may be relevant to determining the interest or intent of the subject. In addition to requesting and displaying recommended content, the user interface submits information on the activity of the subject, including whether the subject completes a desired or targeted outcome, such as making a purchase, booking a hotel, completing a survey, accepting an offer, or an other conversion event for the site. The recommendation system stores all of the recommendation requests and subject outcomes, which are used to build subject profiles in accordance with the present invention.

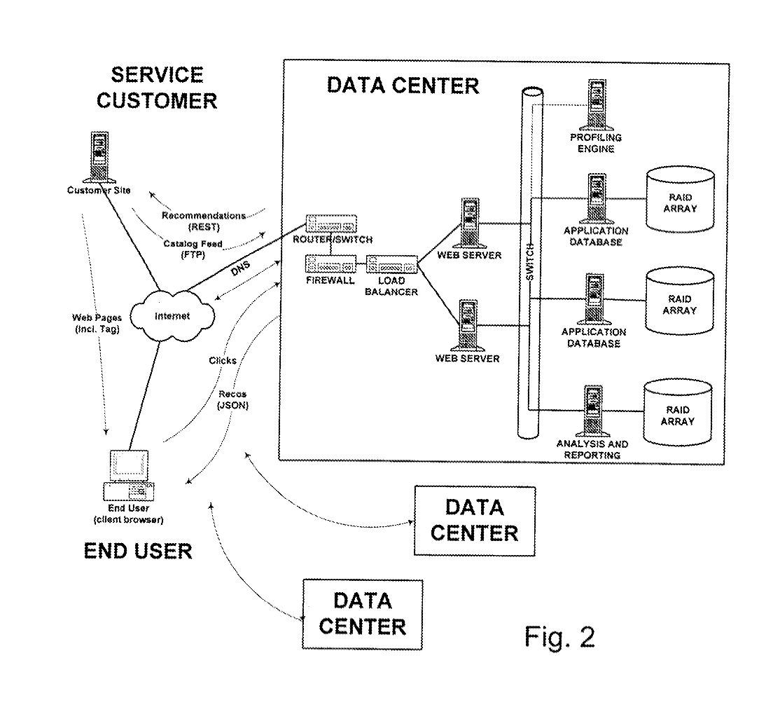

FIG. 2 shows an embodiment of the delivery of the computer implemented web-based system over the Internet. The end use application (Service Customer) is a website that is external to the system and that communicates with the system via web services from the customer website or directly from the customer website's end user's client browser. As shown, the system may be distributed across multiple computers on a network. This consists of one or more web servers (or web farm), which collect data and process content recommendation requests. The web servers pass data to one or more application databases via a message queuing system that allows the web servers to continue processing while the much slower database servers feed the data into permanent storage, such as non-volatile RAM, direct-attached RAID array, network attached storage (NAS), or storage area network (SAN).

Additionally, a profiling engine retrieves affinity and other data from an application database and uses the data to generate the segmentation models, which are then stored back into the application database. The predictive segmentation models, content metadata, and any additional business rules logic are also cached on the web servers for .faster match generation during live operation. In order to process an arbitrarily large number of visitors the web servers are multiplexed using a load balancer, which makes a collection of web servers appear to the Internet as a single server. Also, when a web server becomes unavailable or out of service for any reason, the load balancer automatically transfers traffic to another server. This provides a high level of fault tolerance for the system. In order to provide additional service availability the database and web servers can be replicated to other data centers, through geographic load balancing.

Note that in this embodiment the service has been distributed over multiple servers. In an alternative embodiment all of the functions of the service could be put onto a single or smaller set of servers without a substantive change in the overall functionality of the service. This embodiment also supports multiple Service Customers making simultaneous requests to the web services by allocating different requests to different subsets of servers in the server farm and by creating a separate database for each Service Customer.

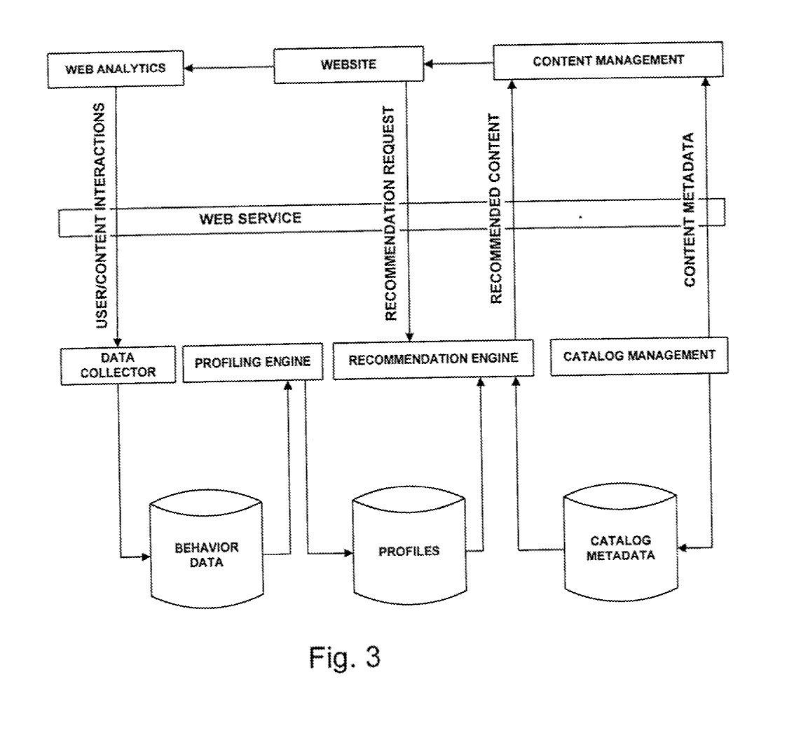

FIG. 3 shows an embodiment of the computer implemented web-based system using web services on a distributed network. The website, content management, and web analytics modules are external to the system and communicate with the data collector, profiling engine, recommendation engine and catalog management modules via web services (REST or SOAP), such as using XML or JSONP. The website requests information from the content management module and displays it on the browser. The browser generates user context and behavior data via the web analytics module. This can be done on the browser itself using JavaScript or on the web server using web logging or packet sniffing, or using other data transfer mechanisms as appropriate to the service customer. Regardless of how this is done, the web analytics submits data via a web service call to the data collector. To display customized content the website requests information from the recommendation engine.

The output of the recommendation engine is fed through the content management module to get the display attributes of the recommended content and then displayed on the website. The content management module not only generates content for the website, it also feeds content information (metadata) to the catalog management module, which stores both information necessary to display content and descriptive attributes that may be applied to filter targeted content according to website-defined business rules or objectives. When a request is made to the recommendation engine for targeted content, the recommendation engine combines the subject profiles with the catalog metadata to find the optimal content subject to any business rules, or other restrictions, put on the results.

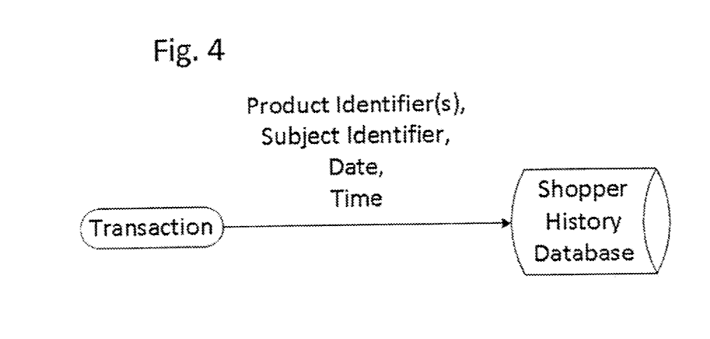

FIG. 4 shows the operation of the computer implemented web-based system to record a set of data called shopper history. In particular, for each transaction the following information is recorded:
For each item in the transaction, the system stores the identity of the product, such as its SKU, description, or other identifying attribute that distinguishes it from other items for sale in the same context.
The system stores an identifier for the subject who made the purchase. This can be done, for example, using the individual's name, a customer number, or some other number or string of text that uniquely identifies a subject among all shoppers.
The system stores the date and time of the transaction to the available precision,

In a sample embodiment, the shopper history is stored in a computer database memory to facilitate the computation of the replenishment interval as described below.

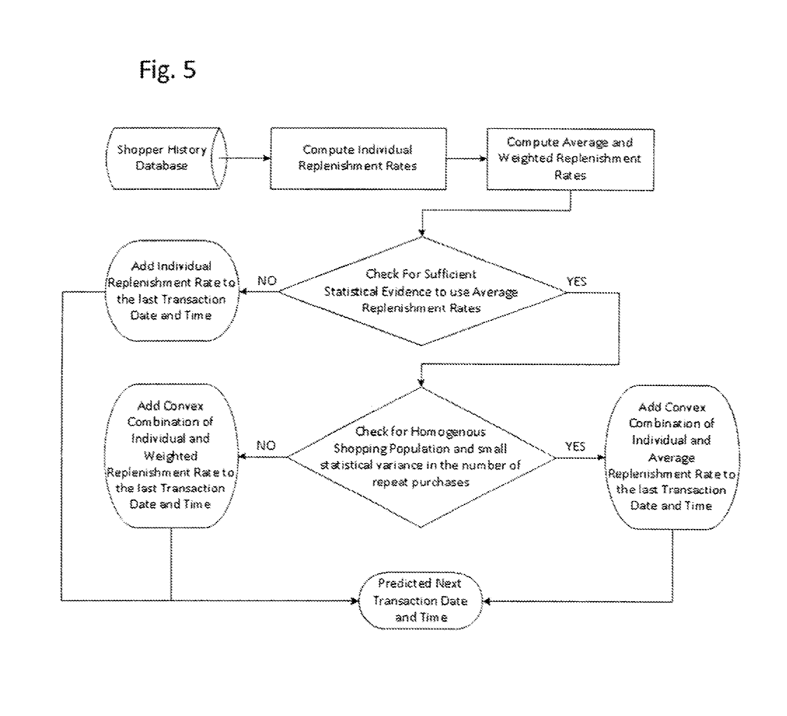

FIG. 5 shows the operation of the system to predict the next transaction date and time of an item by a subject based on the shopper history recorded in FIG. 4. The set of all subjects in the shopper history is represented as a set S with members s₁,s₂, . . . , s_{L}. The set of all products in the shopper history is represented as a set P with members p₁,p₂, . . . , p_{M}. For each distinct pair of subject s and product pⱼ in the shopper history, the computer implemented web-based system computes and records to memory the following quantities:
The total number of times item pⱼ was transacted by subject sᵢ. Let this number be denoted by N_{i,j}.
The first date and time pⱼ was transacted by sᵢ.
The last date and time pⱼ was transacted by sᵢ.
The total number of seconds between the first transaction date and time and the last transaction date and time. Let this quantity be denoted by ΔT.
If N_{i,j} is greater than 1, the system computes the average interval between transactions for subject sᵢ and item pⱼ. This average is called the Individual Replenishment Rate R_{i,j} for the pair sᵢ and pⱼ. For example, the average can be calculated as the mean replenishment interval by calculating the ratio of ΔT divided by N_{i,j}−1, or other methods of averaging. An alternate embodiment for calculating the Individual Replenishment Rate is to calculate the median repurchase interval, which accounts for missing transactions. For example, if a subject makes a transaction outside the view of the system, a particular replenishment interval might appear to be twice its true value. Using the median replenishment interval is less sensitive to such missing data than an average. In another embodiment, the estimate of the individual replenishment rate can be further improved by excluding outlier intervals, for example the shortest or longest intervals between transactions, before calculating either the mean or the median replenishment interval.

The system uses R_{i,j} to compute the following averages. The system computes the Average Replenishment Rate R̅ⱼ̅ for pⱼ as the average of R_{i,j} over all values of i where N_{i,j} is greater than 1 (that is, where a repeated transaction of the same item has occurred) The system computes the Weighted Average Replenishment Rate \hat{R}ⱼ for pⱼ as the average of R_{i,j} over all values of i where N_{i,j} is greater than 1, weighted by (N_{i,j}−1), that is \hat{R}ⱼ=Σ_{f}(N_{i,j}−1)·R_{i,j}. The system then predicts the next likely transaction date and time of pⱼ by sᵢ using R_{i,j}, R̅ⱼ̅, or \hat{R}ⱼ, depending on the distribution of replenishment rates. The system determines if there is sufficient statistical evidence to use R̅ⱼ̅ and \hat{R}ⱼ by requiring that
1. R̅ⱼ̅ and \hat{R}ⱼ are based on repeated transactions by a minimum number of subjects, for example at least 100 different subjects and
2. the sample variance of both R̅ⱼ̅ and \hat{R}ⱼ is less than their respective values by a specified amount, such as 30%; that is, that the population of subjects behave in a reasonably consistent way.

If R̅ⱼ̅ and \hat{R}ⱼ are not reliable due to insufficient statistical evidence, the system predicts the next likely transaction date and time by adding R_{i,j} seconds to last date and time pⱼ was purchased by sᵢ. If R̅ⱼ̅ and \hat{R}ⱼ are reliable, the system next determines whether to use R̅ⱼ̅ or \hat{R}ⱼ by checking whether the statistical variance of N_{i,j} across different shoppers of pⱼ is low. One embodiment of this check consists of uniformly binning the values of N_{i,j} into a specified number of bins, for example 16 bins, and then computing the entropy of the distribution of bin counts. An entropy below 2 bits using base 2 logarithms indicates a low statistical variance of N_{i,j}. The system can also use any other measure of statistical variance to characterize the distribution of the values of N_{i,j}. If R̅ⱼ̅ is available, it is reasonable to assume a homogenous shopping population, and the statistical variance of N_{i,j} across different shoppers of pⱼ is low, the system predicts the next. likely transaction date and time by adding a convex combination of R_{i,j} and R̅ⱼ̅ seconds to last date and time pⱼ was purchased by sᵢ. A convex combination of R_{i,j} and R̅ⱼ̅ is defined as

α·R_{i,j}+(1−α)· R̅ⱼ̅

where α is a continuous value between 0 and 1, inclusive, that determines the weighting or balance between the two rates. The system calculates α as

$$\{ \begin{matrix}1 - \frac{{σ}_{i , j}}{{R}_{i , j}} when {σ}_{i , j} < {R}_{i , j} \\ 0 when {σ}_{i , j} > {R}_{i , j} or when {N}_{i , j} < {N}_{min}\end{matrix}$$

where σ_{i,j} is the sample variance of R_{i,j} and Nₘᵢₙ is the minimum number of transactions, for example 5. The advantage of this method of calculation is that as the variance of R_{i,j} decreases, i.e. the individual replenishment rate becomes more and more precise, the system relies more on it. Alternatively, when it is not reasonable to assume a homogenous set of shoppers or the statistical variance of N_{i,j} across different shoppers of pⱼ is large, the system uses \hat{R}ⱼ, if available, to predict the next likely transaction date and time by adding a convex combination of R_{i,j} and \hat{R}ⱼ seconds to the last date and time pⱼ was purchased by sᵢ.

The advantage of using a convex combination of the Individual Replenishment rate with either the Average Replenishment Rate or the Weighted Average Replenishment Rate is the ability to make a tradeoff between the statistical evidence supporting the Individual Replenishment Rate and the statistical evidence supporting the Average Replenishment Rate. If a subject has a large number of transactions for a particular product, there is little need to rely on the Average Replenishment Rate or the Weighted Replenishment Rate to inform the system on when their next transaction will be for that product. On the other hand, if a subject has purchased a product only once, the system must rely on the Average Replenishment Rate or the Weighted Replenishment Rate to determine the next likely purchase date.

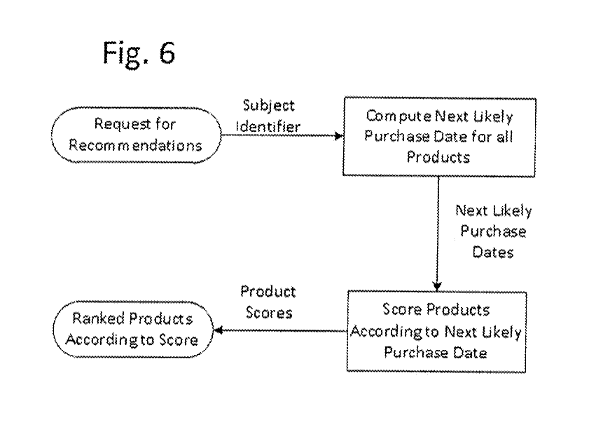

An alternate embodiment of the system uses the above calculations, but instead of computing replenishments for individual products, the system computes replenishment rates for groups of products. That is, N_{i,j} is the number of times any product in a group j was purchased by subject sᵢ, and R_{i,j} is the corresponding replenishment rate. Groups can be based on an attribute of the product, such as category, subcategory, model, or brand. Alternatively, groups can be based on a measure of object similarity such as object vector matching as described in U.S. patent application Ser. No. 12/415,758, US Patent Application Publication No. 20094-248599 A1, filed on Mar. 31, 2009. An advantage of this embodiment is to handle the case of products that are purchased only once, but replaced with similar products from the same manufacturer, supplier, or creator of such products. For example, a subject might purchase multiple pairs of shoes from the same producer over their lifetime, each with a distinct name or design. Another advantage of this embodiment is that the system can recommend (see FIG. 6 below) from within a family of suitable replacement products to generate more variety and relevance in recommendations.

FIG. 6 shows the operation of the system to make product recommendations based on the next likely purchase date and time. The next likely purchase date and time of product pⱼ by shopper sᵢ is represented by D_{i,j}. When it is appropriate to make a product recommendation to a subject sᵢ, for example in the context of a new shopping session on an e-commerce website or as part of a direct mailing marketing campaign, the system computes D_{i,j} for every possible value of j. The system then scores each product according to how far D_{i,j} is from the present. The magnitude of the score is set to be maximal when D_{i,j} is equal to the present. The system decreases the score for a product pⱼ by how far D_{i,j} is from the present. In one embodiment the amount the score is decreased is a linear function of how far D_{i,j} is from the present. Alternatively, the amount the score is decreased is determined by the statistical variability around D_{i,j} and by the shopping behavior the system records. If subjects rarely transact more frequently than a given time interval, for example a week, then the score is decreased by half when D_{i,j} predicts a purchase before a week has passed in addition to being decreased as a linear function of how far D_{i,j} is from the present time.

Another alternate embodiment decreases the score as a function, of 1 divided by how far D_{i,j} is from the present time. The advantage of this alternate embodiment is when the system has a high degree of confidence in D_{i,j}, it will decrease the score more severely when D_{i,j} is farther from the present. An alternate embodiment of the system can use other decreasing functions of how far D_{i,j} is from the present to alter the score a product gets, or combine the above methods. The system ranks all products by their score and then selects the best scoring products to recommend.

An alternate embodiment of the system ranks all products by their score, then adjusts the ranking by preferentially boosting the score of those products that have average or weighted average replenishment rates within a day of the individual replenishment rates of the ten highest ranking products and last purchase dates within a day of the ten highest ranking products. An advantage of this alternate embodiment is that products the subject has not transacted with can be recommended based on the fact that they are commonly transacted at a similar frequency and in coordination with high ranking products. In another embodiment the replenishment scores can be combined with predicted affinities from behavior modeling or satisfaction ratings, and then re-ranked by the combine score. In another embodiment the score of low variance items (hence high likelihood of transaction repetition) can be given an additional score and re-ranked.

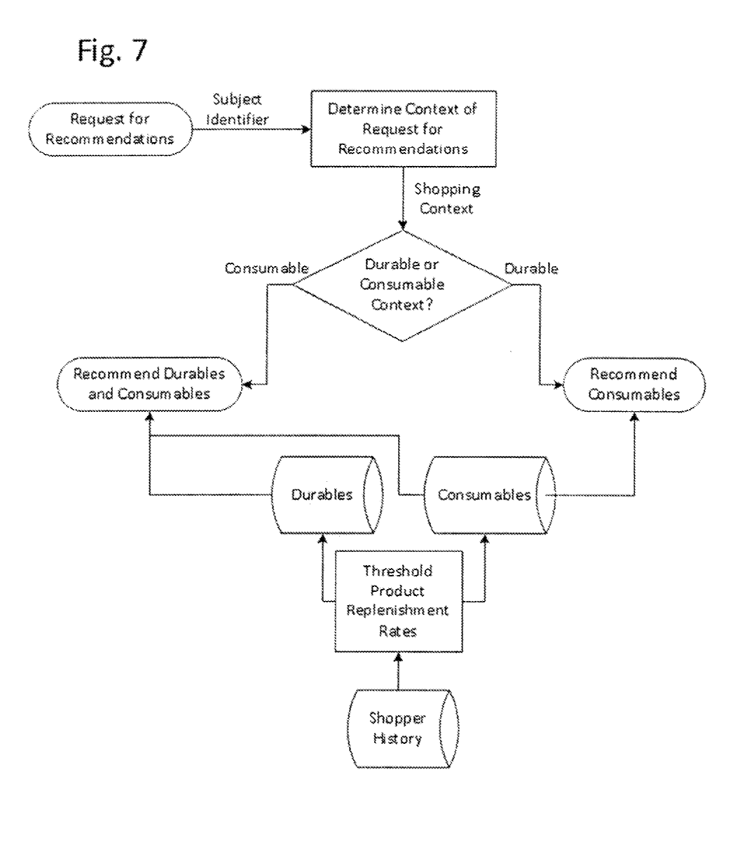

FIG. 7 shows the operation of the system to determine different types of products according to replenishment rate and exploit those characteristics when making product recommendations. In particular, FIG. 7 expands upon the use of the Average Replenishment Rate and Weighted Average Replenishment Rate shown in FIG. 5. In this embodiment, after the system computes the Average Replenishment Rate and Weighted Average Replenishment Rate for every product pⱼ, the system classifies each product as either durable or consumable. This classification is based on the Average Replenishment Rate if it is reasonable to assume a homogenous shopping population, and the statistical variance of N_{i,j} across different shoppers of pⱼ is low, as described above. Otherwise this classification is based on the Weighted Average Replenishment Rate. In either case, a product is classified as consumable if its replenishment rate falls below a given threshold and durable otherwise.

When the system receives a request for recommendations, the context in which the request is made is evaluated to determine if the shopper is considering a durable or consumable product. If the shopper is considering a consumable product, the system might, for example, recommend both durable and consumable products. On the other hand, if the shopper is considering durable products, the system might recommend just consumable products, depending on how the service customer decides to merchandise to their end-user customers. Note that the behavioral classification of products into consumables and durables does not rely on any expert knowledge of the products themselves or any explicit classification supplied by the supplier of the products. Rather, the threshold can be set experimentally by comparing the response of the subject population to different thresholds. Also note that by exploiting a behavioral classification of products, the system makes more relevant product recommendations than if it leveraged just the individual shopper's behavior.

An alternate embodiment of the system classifies products by their propensity to be transacted multiple times. In this embodiment, the propensity of a product to be transacted multiple times is defined as the fraction of all transactions for that product that do not include transactions by subjects with a single transaction with that product. If the propensity to be transacted multiple times is greater than a specified threshold, for example 50%, then the product is classified as a consumable; otherwise it is classified as a durable product. The advantage of this embodiment is that it is unaffected by the natural variability in replenishment rates.

What is claimed is:

1. A computer implemented web-based method for recommending repeated transactions, comprising the steps of:
providing an application client, a recommendation system and an end-user interface;
collecting a set of shopper history data by recording transactions, including repeated transactions, of objects or groups of objects by subjects;
utilizing the duration between transactions to predict the next transaction time of an object by a subject;
predicting a consumer will repeat a transaction for a product from a group of products;
predicting when a consumer will repeat a transaction for an item; and
recommending the object to the subject based on the predicted next transaction time whereby the system recommends said item at a pre-calculated appropriate time.

2. The computer implemented web-based method for recommending repeated transactions according to claim 1, wherein said recommendation system further comprises a computer or network of connected computers such as the Internet, and further wherein a recommendation request can be made through an intermediate server, which then renders the recommendations to the user interface.

3. The computer implemented web-based method for recommending repeated transactions according to claim 1, wherein said end-user interface is implemented using a personal computer, an in-store kiosk, a personal digital assistant (PDA), a mobile phone, a mobile tablet, a set top box, a wireless device, a telephone with voice capability, or a direct marketing mailer.

4. The computer implemented web-based method for recommending repeated transactions according to claim 1, wherein the operation of the computer implemented system to collect and record a set of shopper history data includes recording for each transaction the following information:
for each item in the transaction, the system stores the identity of the product, such as its SKU, description, or other identifying, attribute that distinguishes it from other items for sale in the same context;
the system stores an identifier for the subject who made the purchase by using the subject's name, a customer number, or some other number or string of text that uniquely identities a subject among all shoppers; and
the system stores the date and time of the transaction to the available precision.

5. The computer implemented web-based method for recommending repeated transactions according to claim 1, further wherein the set of all subjects in the shopper history is represented as a set S with members s₁,s₂, . . . , S_{L}; the set of all products in the shopper history is represented as a set P with members p₁,p₂, . . . , p_{M}; and for each distinct pair of subject sᵢ and product pⱼ in the shopper history, the computer implemented web-based system computes the following quantities:
the total number of times item pⱼ was transacted by subject sᵢ; denoted by N_{i,j};
the first date and time pⱼ was transacted by sᵢ;
the last date and time pⱼ was transacted by sᵢ; and
the total number of seconds between the first transaction date and time and the last transaction date and time, denoted by ΔT;
whereby if N_{i,j} is greater than the system computes the average interval between transactions for subject sᵢ and item pⱼ.

6. The computer implemented web-based method for recommending repeated transactions according to claim 5, wherein the calculated average is the individual replenishment rate R_{i,j} for the pair sᵢ and pⱼ, and can be calculated as the mean replenishment interval by calculating the ratio of ΔT divided by N_{i,j}−1, or other methods of averaging.

7. The computer implemented web-based method for recommending repeated transactions according to claim 6, wherein the individual replenishment rate R_{i,j} is calculated as the median interval between purchases of product pⱼ by subject sᵢ.

8. The computer implemented web-based method for recommending repeated transactions according to claim 5, wherein an average replenishment rate R ⱼ̅ for pⱼ is calculated as the average of R_{i,j} over all values of i where N_{i,j} is greater than 1, where a repeated transaction of the same item has occurred.

9. The computer implemented web-based method for recommending repeated transactions according to claim 5, wherein a weighted average replenishment Rate \hat{R}ⱼ for pⱼ is calculated as the average of R_{i,j} over all values of i where N_{i,j} is greater than 1, weighted by (N_{i,j}−1), that is \hat{R}ⱼ=Σᵢ(N_{i,j}−1)·R_{i,j}.

10. The computer implemented web-based method for recommending repeated transactions according to claim 1, wherein the next likely transaction date and time of pⱼ is predicted by sᵢ using R_{i,j}, R̅ⱼ̅, or \hat{R}ⱼ, depending on the distribution of replenishment rates, by determining if there is sufficient statistical evidence to use R̅ⱼ̅ and \hat{R}ⱼ by requiring that:
R̅ⱼ̅ and \hat{R}ⱼ are based on repeated transactions by a minimum number of subjects; and
the sample variance of both R̅ⱼ̅ and \hat{R}ⱼ is less than their respective values such that the population of subjects is statistically consistent.

11. The computer implemented web-based method for recommending repeated transactions according to claim 10, wherein if R̅ⱼ̅ and \hat{R}ⱼ are not reliable due to insufficient statistical evidence, the system predicts the next likely transaction date and time by adding R_{i,j} seconds to last date and time pⱼ was purchased by sᵢ and further wherein if R̅ⱼ̅ and \hat{R}ⱼ are reliable, the system next determines whether to use R̅ⱼ̅ or \hat{R}ⱼ by checking the statistical variance of N_{i,j} across different shoppers of pⱼ, wherein if the statistical variance of N_{i,j} is low then the system uses R̅ⱼ̅, and if the statistical variance of N_{i,j} is high then the system uses \hat{R}ⱼ.

12. The computer implemented web-based method for recommending repeated transactions according to claim 11, wherein the next likely transaction date and time is predicted by adding a convex combination of R_{i,j} and either R̅ⱼ̅ or \hat{R}ⱼ seconds to last date and time pⱼ was purchased by sᵢ; and wherein a convex combination of R_{i,j} and R̅ⱼ̅ is defined as
α·R_{i,j}+(1−α)· R̅ⱼ̅
where α is a continuous value between 0 and 1, inclusive, that determines the weighting or balance between the two rates; and further wherein
a convex combination of R_{i,j} and \hat{R}ⱼ is defined as
α·R_{i,j}+(1−α)·\hat{Rⱼ}
where α is a continuous value between 0 and 1, inclusive, that determines the weighting or balance between the two rates.

13. The computer implemented web-based method for recommending repeated transactions according to claim 11, wherein α is automatically adjusted to weight the individual subject's transactions more heavily as the subject transacts more often.

14. The computer implemented web-based method for recommending repeated transactions according to claim 12, wherein α is calculated as
$$\{ \begin{matrix}1 - \frac{{σ}_{i , j}}{{R}_{i , j}} when {σ}_{i , j} < {R}_{i , j} \\ 0 when {σ}_{i , j} > {R}_{i , j} or when {N}_{i , j} < {N}_{min}\end{matrix}$$
where σ_{i,j} is the sample variance of R_{i,j} and Nₘᵢₙ is the minimum number of transactions.

15. The computer implemented web-based method for recommending repeated transactions according to claim 5, wherein the system uses the replenishment rates calculations to compute replenishment rates for individual products.

16. The computer implemented web-based method for recommending repeated transactions according to claim 5, wherein the system uses the replenishment rates calculations to compute replenishment rates for selecting an item from a group of products.

17. The computer implemented web-based method for recommending repeated transactions according to claim 14, wherein the system determines groups of products by their product attributes, such as category, subcategory, model, or brand.

18. The computer implemented web-based method for recommending repeated transactions according to claim 14, wherein the system determines groups of products by clustering products by behavioral similarity, such as object vector matching.

19. The computer implemented web-based method for recommending repeated transactions according to claim 1, wherein the method is used to make product recommendations based on the next likely purchase date and time calculated.

20. The computer implemented web-based method for recommending repeated transactions according to claim 15, wherein the next likely purchase date and time of product pⱼ by shopper sᵢ is represented by D_{i,j} and is calculated by:
computing D_{i,j} for every possible value of j; then scoring each product according to how far D_{i,j} is from the present; and
wherein the magnitude of the score is set to be maximal when D_{i,j} is equal to the present time and further wherein the system decreases the score for a product pⱼ by how far D_{i,j} is from the present.

21. The computer implemented web-based method for recommending repeated transactions according to claim 16, wherein the amount the score is decreased is a decreasing function of how far D_{i,j} is from the present time, adjusted by the statistical variability around D_{i,j}.
The computer implemented web-based method for recommending repeated transactions according to claim 17, wherein the amount the score is decreased is a linear decreasing function of how far D_{i,j} is from the present time.

22. The computer implemented web-based method for recommending repeated transactions according to claim 17, wherein the amount the score is decreased is 1 divided by how far D_{i,j} is from the present time.

23. The computer implemented web-based method for recommending repeated transactions according to claim 1, wherein the system ranks all products by their score, then adjusts the ranking by preferentially boosting the score of those products that have average or weighted average replenishment rates within a day of the individual replenishment rates of the ten highest ranking products and last purchase dates within a day of the ten highest ranking products.

24. A computer implemented web-based system for classifying and recommending products according to the frequency with which transactions for that product are repeated and the propensity a product will appear more than once in separate transactions by the same subject, by computing the Average Replenishment Rate and Weighted Average Replenishment Rate for every product pⱼ.

25. The computer implemented web-based system for classifying and recommending products according to claim 19, wherein after the system computes the Average Replenishment Rate and Weighted Average Replenishment Rate for every product pⱼ, the system classifies each product as either durable or consumable.

26. The computer implemented web-based system for classifying, and recommending products according to claim 20, wherein the system classifies a product as consumable if its Average Replenishment Rate is less than a specific system-configurable interval and as durable if its Average Replenishment Rate is greater than such interval.

27. The computer implemented web-based system for classifying and recommending products according to claim 20, wherein the system calculates the fraction of transactions of a product that do not include transactions by subjects with a single transaction for that product, and further wherein the system classifies a product as consumable if such fraction is greater than a system-configurable interval and as durable if such fraction is less than such interval.

28. The computer implemented web-based method for recommending repeated transactions according to claim 20, wherein the system classifies all products as either durable or consumable, and further wherein the system uses the classification of a product as durable or consumable to implement a merchandising rule to recommend consumable products against a shopping context of viewing a durable product, and a merchandising rule to recommend consumable products against a shopping context of viewing a consumable or durable product.
